(19) United States
(12) Patent Application Publication
(10) Pub. No.: US 2016/0321356 A1
(43) Pub. Date: Nov. 3, 2016

(54) A DEVICE AND A METHOD FOR ESTABLISHING A PERSONAL DIGITAL PROFILE OF A USER

(71) Applicant: INUITIVE LTD., Ra'anana (IL)

(72) Inventors: Ziv TSOREF, Tel Aviv (IL); David BEN-BASSAT, Ganey Tikva (IL)

(21) Appl. No.: 15/108,645

(22) PCT Filed: Dec. 18, 2014
(86) PCT No.: PCT/IL2014/000065

§ 371 Date: Jun. 28, 2016

Related U.S. Application Data
(60) Provisional application No. 61/921,529, filed on Dec. 29, 2013.

(51) Int. Cl. G06F 17/30; G06K 9/00

(52) U.S. Cl. CPC G06F 17/30702; G06F 17/30657; G06K 9/00926; G06K 9/00335

(57) ABSTRACT

An electronic device is provided which comprises a plurality of different sensors, each configured to retrieve data relating to at least one characteristic of a user; a processor configured to: receive data retrieved by the different sensors; and establish features that characterize the user based upon data received from at least two of the different sensors; a storage configured to store information that relates to the features that characterize the user; and wherein the processor is further configured to: receive new data that has been retrieved by the different sensors which relates to the features that characterize the user; retrieve information from the storage that relates to the features that characterize the user and compare the stored information with the newly received data; and based on the comparison, determine whether to generate a user related output and/or replace stored information with information derived from the newly received data.

### TECHNICAL FIELD

The present disclosure generally relates to electronic devices, and more particularly, to electronic devices that comprise sensors which may be used to monitor users' activities.

### BACKGROUND

Currently, a human-computer interaction (referred to hereinafter as “HCl”) is typically carried out by using a rather crude and explicit questions-answers type of interaction. At the same time, human-human interaction has been carried out throughout the history as a multifaceted type of interaction, consisting of many interactive feedbacks which are based upon interactions between interlocutors, which take into account, among others, social elements (e.g. display rules, social state), moods, feelings, personal goals, nonverbal and paralinguistic communication channels and more.

As human-human interaction is by far more developed than HCl, there is a need to diminish the gap that exists between these two types of interactions, by improving the HCl so that computing devices are able to perceive and better understand in an effective way, users who interact with them, as well as become aware of (and take into consideration for interacting purposes) the user's social signals embedded within multiple behavioral cues.

One example that is well known in the art is the use of speech recognition, to enable computing devices to respond to verbal commands expressed by the users of these devices. Microsoft® Windows® offers such a speech recognition feature. However, in order to activate this feature properly, a long session of training is typically required. During such a training session, the user is required to read lengthy texts in order to allow the system to get acquainted with his/her personal voice and accent, thereby to enable the computing device to understand future commands expressed by that user.

In addition, there are several cloud based expert systems, which serve as medical diagnostic tools. The use of these systems is typically based upon feeding specific symptoms to the expert system by the user, and in return the expert system generates possible diagnostics of potential health issues. These expert systems are usually cloud based solutions, and do not contain any personal information of the user. Furthermore, these systems expect the user to feed the symptoms to them, rather than being able to collect these symptoms seamlessly by using for example auxiliary sensors.

### SUMMARY OF THE DISCLOSURE

The disclosure may be summarized by referring to the appended claims.

The solution provided herein relies on the fact that personal computers become part of our daily lives as a tool for carrying out vast and diversified functions, and as such, people find themselves spending an increasing number of hours, facing these devices. These time periods may be utilized to collect information about the user. By employing multiple sensors, diversified information about the user may be collected, and by processing the accumulated information, a personal digital personal profile of the user may be generated. Such a profile may represent user properties, behavioral models and habits, thereby providing means to improve the HCI.

It is therefore an object of the present disclosure to provide a method and a system for generating a personal user profile on an electronic computing device (e.g. a personal computer, a tablet, a smartphone, and the like), which is based upon accumulated data, collected by various sensors operated by that computing device.

It is another object of the present disclosure to provide a method and a system for using the generated user profile to identify irregularities in the user's behavior, for example to identify situations where a user deviates from his/her so called ‘normal’ profile and habits. Such deviations may be used to generate alerts when a substantial change is detected in the user's current behavior, as compared with his/her normal behavior.

Other objects of the present invention will become apparent from the following description.

According to one embodiment, there is provided an electronic device comprising:
a plurality of different sensors, each configured to retrieve data that relates to at least one characteristic of a user;
one or more processors configured to:
   receive data retrieved by the plurality of different sensors; and
   establish at least one feature that characterizes the user, wherein the establishment of the at least one feature is based upon data received from at least two of the plurality of different sensors;
a storage configured to store information that relates to the at least one feature that characterizes the user; and
wherein the one or more processors are further configured to:
   receive new data that has been retrieved by the at least two of the plurality of different sensors, which relates to the at least one feature that characterizes the user;
   retrieve information from the storage, that relates to the at least one feature that characterizes the user and compare the stored information with the newly received data; and
   based on the comparison between the stored information and the newly received data (i.e. information that relates to the at least one feature), determine whether to generate a user related output and/or replace stored information that relates to the at least one feature that characterizes the user, with information derived from the newly received data.

According to another embodiment, the output generated based on the comparison between the stored information and the newly received data, is an alert.

By yet another embodiment, the output generated based on the comparison between the stored information and the newly received data, comprises indication of a difference that exists between the stored information and the newly received data.

In accordance with still another embodiment, the output generated based on the comparison between the stored information and the newly received data, comprises a recommendation for an action to be taken by said user, based upon a difference that exists between the stored information and the newly received data. In addition or in the alternative, no on-going search is conducted to detect irregularities in the user current behavior (when compared to his/her normal profile), and the currently available profile (which is based upon last retrieved information) is used, to provide continuous updated ‘state of the user’ information for later analysis (for example in Big Data Services).

According to another aspect, there is provided a method for establishing a digital personal profile of a user, comprising the steps of:
collecting data by a plurality of different sensors, wherein said different sensors are associated with an electronic device and configured to be operated by a processor comprised in said electronic device, and wherein data collected by each of the plurality of different sensors relates to at least one characteristic of a user;
establishing at least one feature that characterizes said user, wherein establishment of the at least one feature is based upon data received from at least two of the plurality of different sensors;
storing information that relates to said at least one feature that characterizes said user;
receiving new data retrieved by the plurality of different sensors that relates to the at least one feature that characterizes said user;
comparing the stored information that relates to the at least one feature that characterizes said user with the newly received data; and
in case there is a substantial difference between the stored information and the newly received data, determining whether to affect a change in the stored information and/or to generate an output that relates to the user.

In accordance with another embodiment of this aspect, the output generated based on the comparison between the stored information and the newly received data, is an alert.

By yet another embodiment of this aspect, the output generated based on the comparison between the stored information and the newly received data, comprises indication of a difference that exists between the stored information and the newly received data.

According to still another embodiment of this aspect of the disclosure, the output generated based on the comparison between the stored information and the newly received data, comprises a recommendation for an action to be taken by said user, based upon a difference that exists between the stored information and the newly received data.

In accordance with another aspect, there is provided a computer program product encoding a computer program stored on a non-transitory computer-readable medium for executing a set of instructions by one or more computer processors for launching a process for establishing a digital personal profile of a user of an electronic device that comprises a plurality of different sensors associated with the electronic device and configured to be operated by said one or more computer processors, wherein the process comprises the steps of;
activating the plurality of different sensors associated with the electronic device to collect data that relates to at least one characteristic of the user;
establishing at least one feature that characterizes said user, wherein establishment of the at least one feature is based upon data received from at least two of the plurality of different sensors;
storing information that relates to said at least one feature that characterizes said user;
receiving new data retrieved by the plurality of different sensors that relates to the at least one feature that characterizes said user;
comparing the stored information that relates to the at least one feature that characterizes said user with the newly received data; and
in case there is a substantial difference between the stored information that relates to the at least one feature that characterizes said user and the newly received data, determining whether to affect a change in the stored information and/or to generate an output that relates to the user.

### BRIEF DESCRIPTION OF THE DRAWINGS

For a more complete understanding of the present invention, reference is now made to the following detailed description taken in conjunction with the accompanying drawing wherein:

FIG. 1—is a flow diagram exemplifying a method carried out in accordance with an embodiment of the present invention.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

According to an embodiment of the present disclosure, the following mechanism may be applied in order to carry out that embodiment:

a. Creating a digital personal profile for a user, by applying an adaptive process which, according to this example, comprises the following two steps:
i. Collecting parameters associated with a new user and converge them to form a new digital personal profile for that user; and
ii. After obtaining the converged parameters, the second steps involves tracking changes (even relatively minute changes) in the user's behavior, and updating the parameters that form the digital personal profile of the user based on the detected changes in a more refined way;

b. Whenever a new behavioral cue is retrieved based on the collected data, a decision is made to determine whether the newly retrieved cue is in line with the already formed digital personal profile of the user. If the decision is affirmative, the digital personal profile of the user would be updated accordingly. However, if the decision is negative, an alert is initiated.

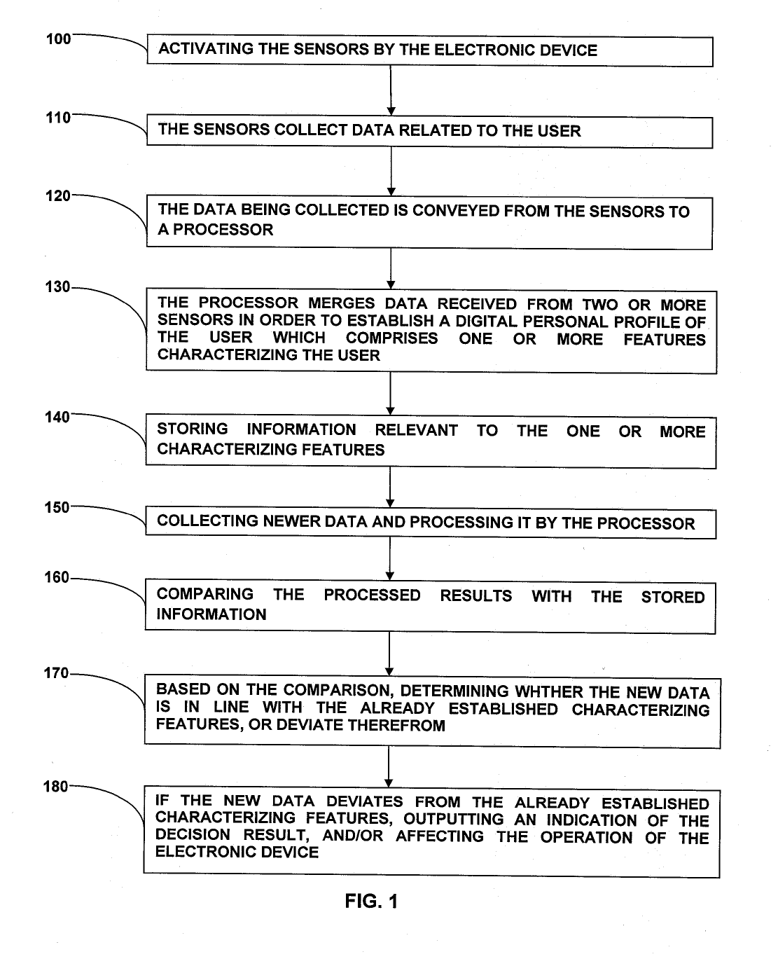

According to an example of an embodiment of the present disclosure illustrated in FIG. 1, there is provided a method for generating and using a digital personal profile of a user. The method is carried out by an electronic device and a number of sensors associated therewith, which may be activated by that electronic device. Once the electronic device activates the sensors (step 100) for the purpose of generating and/or monitoring the digital personal profile of a user, the sensors start collecting data (step 110) which relates to the user currently present at the vicinity of the electronic device and convey the collected data (step 120) to a processor comprised in the electronic device.

According to an embodiment of the disclosure, before the collection of data begins, there is identification of the user, preferably but not necessarily this identification is carried out automatically and does not require any active interaction with the user in the process, e.g. by activating one or more of the sensors that would allow identifying the user who is currently at the vicinity of the electronic device (for example through the use of face recognition, speech recognition, body language or any other applicable type of recognition).

The processor merges the data received from two or more of the sensors in order to establish a digital personal profile of the user (step 130), where this digital personal profile comprises one or more features that characterize the user. Once a characterizing feature has been established (e.g. when further data received from respective sensors, do not change substantially the determination made regarding the already established feature), the information relevant to the established characterizing feature is stored at the memory of the electronic device (step 140) as part of the user's digital personal profile. Thereafter, sensors may be activated by the electronic device either on a continuous mode (as long as the user is still at the vicinity of the electronic device), or at every pre-determined period of time (e.g. every x minutes during the period at which the user is present at the vicinity of the electronic device) or any combination thereof, to continue collecting data relevant to the characteristic features of the user. The data collected from the various sensors is then processed by the processor (step 150) and the processed results are compared with the information stored at the device memory (step 160). Based on this comparison, the processor determines whether the newly collected data are in line with the established characterizing feature or deviate therefrom (step 170), and in the latter case, the processor may output its findings (e.g. by generating an alert that will be displayed at the display of the user's electronic device or be sent to another pre-determined address) (step 180). In the alternative the determination made by the processor in step 170 may be used to affect the operation of the electronic device itself. By yet another alternative, based on the newly collected data, the processor may modify the information stored in the device memory which defines the characterizing features (e.g. when the change in the newly collected data is consistent for a pre-defined number of occasions during which data was collected) and the modified data will then be stored in the memory of the electronic device to represent the characterizing feature. The latter embodiment enables to provide a digital personal profile of a user that is dynamically updated to adequately reflect new changes in the user behavior, health, etc.

The electronic device to which the present disclosure refers, may be a device having computing capabilities such as a laptop, a personal computer, a tablet, a smartphone and the like, which may be used for establishing a digital personal profile of their respective user based on information retrieved from two or more sensors comprised in the electronic device. The information is preferably continuously accumulated as long as the user is present at the vicinity of the electronic device and may be used to dynamically update the user's digital personal profile.

Examples of possible sensors are:
a microphone, or microphone array, used to record the user voice, and/or other non-vocal sounds; and/or
a camera (e.g. a web cam) for capturing visual information associated with the user; an/or
Infra-red camera(s), used to capture information in the IR domain that is associated with the user; and/or
depth sensor(s) (which also may be referred to as “3D cameras”) to capture 3D information associated with the user; and/or
use of one or more computer accessories such as touch screen, mouse, keyboard and Voice User Interface, which are characteristic of a specific user;
etc.

Although the above disclosure relates to sensors that are comprised within the electronic device, it should be understood that the present invention also encompasses cases where the sensors are connected to the electronic device but do not comprise a part thereof.

Using multiple information sources derived from the different sensors, enables establishing a more accurate, comprehensive and in-depth digital personal profile of the user. For example, merging visual and vocal data, enables gaining a better understanding of the human behaviour.

Obviously, the user may use the electronic device for any purpose known in the art, selected from among the many different and diversified options available. As the user makes use of the electronic device, he/she will most likely be present at the vicinity of that electronic device. Upon detecting the presence of the user at the vicinity of the device (e.g. when the user identifies himself/herself while performing a log-in procedure at the electronic device, or by detecting a presence of person next to the device by one or more of the device's sensors and then identifying that person as the user of the device based on information stored at the memory of that device), one or more (but not necessarily all) of the available sensors are activated, and begin collecting information that relates to the user.

The collected information may relate to physical features of the user, his/her activities while using the electronic device, and the like. As the information is being retrieved, an algorithm which is preferably executed as a background program by the one or more processors of the electronic device, may extract some user-related features and behavioral cues from the collected information in order to establish the one or more characteristic features of the user. For example:
Posture of the user;
Mimics and typical facial expressions of the user, eyes' blinking rates, pupil size, head movements eyes' gazing/movements;
Voice, tonality, speech rate, pitch, coughs, non-verbal sounds and other vocal related characteristics;
Skin tone, and variations of skin tone;
Non-intentional movements, body language and gestures; and
Expression recognition.

According to one embodiment of the disclosure, the physical information is gathered together with context related information, e.g. what has the user been engaged with at the time the information has been retrieved:
Reading a web page;
Going through mail;
Selecting an icon;
Consuming multimedia;
Gaming;
Web browsing;
Web chatting;
Etc.

The user-related information may be collected in terms of physical data such as:
Rates of behavioral cues, gestures and facial expressions;
Speeds of body movements (where the speed is calculated based on movement of the user hands and/or fingers and/or eyes, etc.)
Order of cues and gestures.

Upon extracting user-related information captured by the plurality of sensors, a digital personal profile of the user, which comprises one or more features characterizing the user, may be generated. The profile may contain various user-specific features, such as:
Response to a funny mail;
Voice tonality versus stress and facial expressions;
Skin color (can be correlated with the user's health);
Habits (e.g. always open the same web site in the morning, always read mails at the same time of day, and the like).

Such a personal digital personal profile may be an evolving and be associated with a dynamically adaptive data base. As time passes, further information about the user characteristics will be accumulated. Naturally, the more information accumulated, the more detailed and accurate the digital personal profile of the user will be.

There are various ways in which the characteristic features (the user digital personal profile) may be used, and they should all be understood as being encompassed by the present invention, among which are:
To speed up computer-user interaction when performing routine, everyday tasks. For example, when the one or more processors of the electronic device determine that the user is acting with high confidence, they will generate a quick response to every cursor movement in the attempt to allow the user to proceed with the required operations (steps), with practically almost no time to wait in between these operations.
On the other hand, when the user exhibits hesitation and uncertainty regarding his/her next step while carrying out a multi-step task, the processor may slow down the paste at which the operations are carried out and may preferably retrieve more information for providing that information to the user, in order to assist the latter in taking his/her decision on the next step to be followed. This can be done in any one or more ways, such as by providing the user with textual information relevant to the current step of the task or the task as a whole, and/or simply by highlighting certain icons, increasing fonts' size of relevant texts, etc.
To determine health problems associated with the user, such as high fever, tiredness etc. by processing information received from the sensors that relates to changes in skin color, gesture-speed and accuracy, non-typical confusion in performing simple tasks, etc.

Once the personal digital personal profile of the user (i.e. one or more characterizing features of the user) has been stabilized, e.g. after collecting a predetermined amount of relevant data or after establishing that data which represent a current characterizing feature is essentially identical to data that had been collected in the past and was used to establish this characterizing feature, the profile may be used to keep track after the user in order to identify occurrence of deviations from his/her expected behavior (characteristic feature(s)), by determining for example one or more of the following:
A higher than normal blinking rate;
Change(s) in the user's posture;
Change(s) in the user's voice pitch.

When one or more irregularities in the user's profile are detected, the electronic device may refer these findings to a pre-determined address (such as for example an expert software residing either in an IP cloud or executed at a host device) in order to analyze the findings and reach a conclusion as to the problem. Once such a conclusion has been reached, the expert software may:
Provide the user with an alert as to the irregularity detected;
Provide the user with possible reasons (medical or others) which relate to the irregularities in the digital personal profile that had been detected;
Recommend relevant action to be taken by the user (medical tests, change of the user's chair, change of room lighting, etc.);
Keep a detailed log for later analysis.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. An electronic device comprising:
a plurality of different sensors, each configured to retrieve data that relates to at least one characteristic of a user;
one or more processors configured to:
receive data retrieved by the plurality of different sensors; and
establish at least one feature that characterizes said user, wherein the establishment of the at least one feature is based upon data received from at least two of the plurality of different sensors;
a storage configured to store information that relates to the at least one feature that characterizes said user; and
wherein the one or more processors are further configured to:
receive new data that has been retrieved by the at least two of the plurality of different sensors, which relates to the at least one feature that characterizes said user;
retrieve information from the storage that relates to the at least one feature that characterizes said user and compare the stored information with the newly received data; and
based on the comparison between the stored information and the newly received data, determine whether to generate a user related output and/or whether to replace stored information that relates to the at least one feature that characterizes the user with information derived from the newly received data.

2. The electronic device of claim 1, wherein the output generated based on the comparison between the stored information and the newly received data, is an alert.

3. The electronic device of claim 1, wherein the output generated based on the comparison between the stored information and the newly received data, comprises indication of a difference that exists between the stored information and the newly received data.

4. The electronic device of claim 1, wherein the output generated based on the comparison between the stored information and the newly received data, comprises a recommendation for an action to be taken by said user, based upon a difference that exists between the stored information and the newly received data.

5. A method for establishing a digital personal profile of a user, comprising the steps of:
collecting data by a plurality of different sensors, wherein said different sensors are associated with an electronic device and configured to be operated by a processor comprised in said electronic device, and wherein data collected by each of the plurality of different sensors relates to at least one characteristic of a user;
establishing at least one feature that characterizes said user, wherein establishment of the at least one feature is based upon data received from at least two of the plurality of different sensors;
storing information that relates to said at least one feature that characterizes said user;
receiving new data retrieved by the at least two of the plurality of different sensors that relates to the at least one feature that characterizes said user;
comparing the stored information that relates to the at least one feature that characterizes said user with the newly received data; and
in case there is a substantial difference between the stored information and the newly received data, determining whether to affect a change in the stored information and/or whether to generate an output that relates to the user.

6. The method of claim 5, wherein the output generated based on the comparison between the stored information that relates to said at least one feature that characterizes the user and the newly received data, is an alert.

7. The method of claim 5, wherein the output generated based on the comparison between the stored information the newly received data, comprises indication of a difference that exists between the stored information and the newly received data.

8. The method of claim 5, wherein the output generated based on the comparison between the stored information and the newly received data, comprises a recommendation for an action to be taken by said user, based upon a difference that exists between the stored information and the newly received data.

9. A computer program product encoding a computer program stored on a non-transitory computer-readable medium for executing a set of instructions by one or more computer processors for launching a process for establishing a digital personal profile of a user of an electronic device that comprises a plurality of different sensors associated with the electronic device and configured to be operated by said one or more computer processors, wherein the process comprises the steps of;
activating the plurality of different sensors associated with the electronic device to collect data that relates to at least one characteristic of the user;
establishing at least one feature that characterizes said user, wherein establishment of the at least one feature is based upon data received from at least two of the plurality of different sensors;
storing information that relates to said at least one feature that characterizes said user;
receiving new data retrieved by the at least two of the plurality of different sensors that relates to the at least one feature that characterizes said user;
comparing the stored information that relates to the at least one feature that characterizes said user with the newly received data; and
in case there is a substantial difference between the stored information and the newly received data, determining whether to affect a change in the stored information and/or whether to generate an output that relates to the user.
